(19) United States
(12) Patent Application Publication
(10) Pub. No.: US 2008/0091579 A1
(43) Pub. Date: Apr. 17, 2008

(54) HEALTH CARE PAYMENT SYSTEM AND METHOD

(76) Inventor: J. Christopher Barrett, San Diego, CA (US)

Correspondence Address: BAKER & DANIELS LLP, 300 NORTH MERIDIAN STREET, SUITE 2700, INDIANAPOLIS, IN, 46204, US

(21) Appl. No.: 11/843,113

(22) Filed: Aug. 22, 2007

Related U.S. Application Data
(60) Provisional application No. 60/823,391, filed on Aug. 24, 2006.

(51) Int. Cl. G06Q 20/00; G06Q 40/00

(52) U.S. Cl. 705/34; 705/39

(57) ABSTRACT

The present invention involves a health care reimbursement pricing system that enhances a Provider's ability to pay for high-cost therapeutics, while accelerating payment to the Seller.

### BACKGROUND OF THE INVENTION

1. Field of the Invention

The invention relates to the field of health care pricing systems, and more particularly to a health care provider's payment to a manufacturer of therapeutics.

2. Description of the Related Art

There was a time when people needed medical attention they paid the doctor directly for his or her professional services. Times have changed. Modern medicine can work miracles our grandparents never dreamed of, but sometimes at a staggering price. The provision of critical healthcare treatment is often regarded as a basic human right, regardless of whether the individual has the means to pay—at the same moment some forms of healthcare treatment cost more than a typical family's life savings. These days most Americans rely on a third party—either a private insurer, or a public governmental entity—to help them finance the cost of their medical needs.

Representing over 20 percent of the U.S. Gross Domestic Product, the health care industry is the single largest market in the U.S. today. Although the healthcare industry is a commercial market today, it didn't start out that way. In fact, the origins of these plans resided with providers (doctors and hospitals) and their desire to streamline the financial reimbursement process. In the beginning many managed care plans were formed by providers to provide predictable and reliable payment systems, or by companies to control employee medical costs. Over the course of the twentieth century healthcare plans evolved from being provider run, to adding employer run plans, to being financial institutions for all parties in the health care field much like insurance companies.

Toward the middle of the twentieth century health benefits began to be offered as an incentive to increase employment numbers. In the sixties, Medicare and Medicaid were formed by the Federal Government to help provide medical care to the elderly and poor, respectively. Toward the end of the twentieth century the majority of people were enrolled in some form of health insurance plan, with health maintenance organizations (HMO's) the most common. Today, the healthcare industry is a huge business, with many large managed care companies traded on the stock exchange. The healthcare industry accounts for approximately $1.5 trillion in market revenue.

Prescription drug spending is one of the fastest growing components of national health care spending, increasing at double-digit rates in each of the past 8 years. From 1993 to 2004, the number of prescriptions purchased increased 70% (from 2.0 billion to 3.7 billion), compared to a U.S. population growth of 13%. Additionally, U.S. spending for prescription drugs is projected to increase by 10.7 percent annually through 2013. As a subset of prescription drugs, High-Cost Therapeutics used by specialty Providers for in-office administration represent a growing portion of prescription drug sales.

The added complexities of the current health care system and the sheer volume of medicines being manufactured and administered has resulted in a long payment cycle. The health care provider cannot pay the manufacturer until the provider has received payment from the patient and/or the patient's insurance company or a government assistance program, which might also prove challenging. Today's health care organizations and individual providers face challenges processing and getting reimbursed for medical insurance claims. Shrinking reimbursement margins from governmental Payors under the Medicare Modernization Act of 2003 (“MMA”) and from certain commercial Payors influenced by the pricing paradigm created by the MMA has also put pressure on Providers that buy and bill for high-cost drugs administered in the Provider's office. Additionally, Manufacturers are subject to a variety of third-party influences on the selling price of their product that creates inefficiency and expense in the delivery of such High-Cost Therapeutics.

### SUMMARY OF THE INVENTION

The present invention is a software tool that promotes efficiency in the delivery system for high-cost therapeutics consistent with the MMA, and enhances a health care service Provider's ability to pay for high-cost therapeutics, while accelerating payment to the Manufacturer. Specifically, the software tool is an automated, non-credit process governed by dynamic algorithms linked to purchase and payment authorization codes used to facilitate the Provider's acquisition of drugs through payment mechanisms and potential financing options and to accelerate payments to the Seller (including Manufacturers, Special Pharmacies, Distributors, and other resellers), through a process that automatically assigns to the Payment Facilitator title to the subject accounts receivable. Current methods employed by some health care organizations include a financing system based on credit information obtained at the patient level. The fees and costs with specified health care services are computed and the credit information for a patient is obtained. A health care consumer note is issued for the patient for at least a portion of the computed fees and costs based on the obtained credit information. A provider may then be paid with funds that correspond to the determined cash value of the consumer note. Since the payment to the provider is accelerated, the process may speed up payment from the provider back to the manufacturer. In the present invention, a credit analysis is done at the provider level, rather than the patient level to increase efficiency and to reduce cost.

One embodiment of the present invention begins with a Seller of high-cost therapeutics (“HCT”) agreeing to work within the program. The Payment Facilitator enters into such an agreement after evaluating the HCT involved in terms of type, sales price and volume, sales terms, and invoice and accounts receivable (A/R) history, evaluating the system the Seller currently uses for invoicing and delivering the HCT, and obtaining the Seller's agreement to provide to the Payment Facilitator customer information after such customer's agree to participate in the Provider side of the program. The information will be stored electronically and the Payment Facilitator and the Seller will share customer credit information. A health care Provider wishing to join the program is evaluated via a credit analysis. The provider can be an individual practice, a group of doctors, a hospital, or other health care providing organization. The Provider is rated pursuant to a credit analysis involving traditional business credit analysis combined with a review of Payor Contracts, review of documentary compliance under Payor Contracts, and claims research regarding claims related to specific HCT's used by the Provider. Once the Provider is accepted, the Provider is assigned a Customer Code and credit limit. The full customer code will contain fields indicating that customer is Provider is participating in this program along with its credit limit and/or rating. The credit limit is determined, in part, by viewing average monthly claims history, Seller A/R data if available, and comparing those numbers to the credit score. The Payment Facilitator then activates the Provider's Account and card within its payment system using either a Point of Sale (POS) terminal or an electronic portal. The Payment Facilitator then distributes the card and account information to the Provider with a copy to the Seller.

If a Patient requires a prescription, the Provider orders the prescription from the Seller using the assigned Customer Code. The Provider can order via paper request, facsimile, EDI, and/or web interface depending upon the Provider's systems and the Seller's requirements. The order will include the Customer Code, the provider name, the therapeutic being ordered, and the quantity. The order will sometimes include a price based on existing contracts or specific promotions. The Seller verifies the Customer Code, allowing the Seller to determine if the order will be processed using the Payment Facilitator's purchases authorization system. If the Customer Code is a valid code, the Seller verifies the Provider's credit limit through a shared or separately maintained database. If the order is within the customer's credit limits, then the Seller notifies the Payment Facilitator of the order through an EDI or web-based portal identifying the order by reference number, including the drug, order quantity and dollar amount and the Payment Facilitator commits to acquiring A/R that falls within the commitment. The Seller then ships the drug to the Provider. The Payment Facilitator may verify the order directly with the Provider.

The Seller then prepares an invoice for the order. Depending upon the shipping terms, the Seller classifies the invoice as an Account Receivable upon delivery of the drug to the shipping point or the destination. The Seller then submits to the Payment Facilitator through paper, facsimile, EDI, or web portal the Accounts Receivable data, which includes the invoice date, the invoice number, the commitment reference number, the terms, the drug, the quantity, and the dollar amount. The Payment Facilitator verifies the A/R data to the commitment data either electronically or manually by comparing the reference number, drug, provider, quantity and amount.

If the A/R data does not reconcile with the commitment data, then the Payment Facilitator contacts the Seller and Provider to reconcile the order and A/R data and determine whether it will acquire A/R related to the subject order. If the A/R is not reconciled within the commitment data, the Payment Facilitator is not obligated to acquire the A/R and does not acquire the A/R.

If the Provider is within their assigned credit limit and the Payment Facilitator has reconciled the A/R data to the commitment, the Payment Facilitator purchases the A/R by sending the reconciled A/R amount to the Seller, less the applicable service fee, via EFT and the Payment Facilitator thereby acquires ownership and title of the A/R pursuant to provisions in the agreement between the Payment Facilitator and the Seller.

The Payment Facilitator later collects from the Provider in one of several ways. The Payment Facilitator may collect by sweeping a lockbox account, by taking an assignment of A/R from the Provider of payments due by Insurance Company/Government and/or Patient, or a combination thereof.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic representation of the organizations in the health care system implementing the methods of the present invention.

FIGS. 2a and 2b are flowcharts depicting a health care provider's payment to a manufacturer of therapeutics.

FIG. 3 is a schematic diagrammatic representation of the hardware and software systems implementing the methods of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions that follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory; rather they represent specific electronic structural elements that impart a physical organization on the information stored in memory. More than mere abstraction, the data structures are specific electrical or magnetic structural elements in memory that simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein that form part of the present invention; the operations are machine operations. Useful machines for performing the operations of the present invention include general-purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general-purpose computer as selectively activated or reconfigured by a computer program stored in the computer. The algorithms presented herein are not inherently related to any particular computer or other apparatus. In particular, various general-purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects. Objects may also be invoked recursively, allowing for multiple applications of an object's methods until a condition is satisfied. Such recursive techniques may be the most efficient way to programmatically achieve a desired result.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The term “Browser” refers to a program which is not necessarily apparent to the user, but which is responsible for transmitting messages between the workstation and the network server and for displaying and interacting with the network user. Browsers are designed to utilize a communications protocol for transmission of text and graphic information over a worldwide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”). The terms “wireless application protocol” or “WAP” mean a universal specification to facilitate the delivery and presentation of web-based data on handheld and mobile devices with small user interfaces.

In relation to the Health Care field, this document uses some terms with specialized meanings. For example, “Payment Facilitator” is a reference to a generic financial processor. The term “Nova” is a reference to a generic payment mechanism or system that may be implemented in several forms, and the term “PACRx” is a reference to a transaction card with an associated account number used by the Nova system. The terms “therapeutics” and “prescription” are meant to encompass all of pharmaceutical drugs, medical devices, and other materials used in the provision of health care to an individual. The term “order” refers to an amount of therapeutics or prescriptions that are to be delivered to a health care provider to administer a medical treatment to an individual. The term “provider” is refers to an individual physician or other health care organizations that are involved in the provision of health care to one or more individuals. The term “payor” refers to the individual or organization providing some or all direct payment or reimbursement for a health care transaction. The term “seller” refers to manufacturers, special pharmacies, distributors, and other resellers. The term “credit limit” refers to the maximum amount of money that can be charged on a particular account.

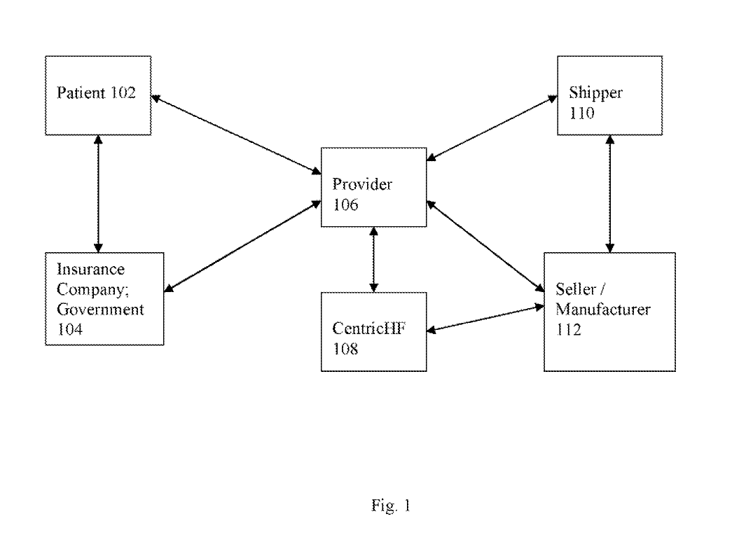

One embodiment of the present invention is depicted in FIGS. 1-3. The process begins when Seller 112 (either Shipper, Manufacturer, or some other seller of the drug) agrees to participate in the Payment Facilitator's payment authorization system. Payment Facilitator 108 evaluates the particular high-cost therapeutic (HCT) being sold, the terms under which the therapeutic is sold, the general sales volume and pricing, and the systems in place for generating invoices and tracking customer credit limits and standing. Payment Facilitator 108 also verifies the financial standing of Seller 112. Seller 112 agrees to provide any relevant customer (Provider 106) information to Payment Facilitator 108 upon customer approval. Payment Facilitator 108 then determines the applicable service fee to charge Seller 112 based on the foregoing. If Seller 112 and Payment Facilitator 108 arrive at mutually agreeable terms for the fee, Seller 112 and Payment Facilitator 108 enter into a written agreement outlining such terms and the parties' relative obligations to provide information and/or services to one another.

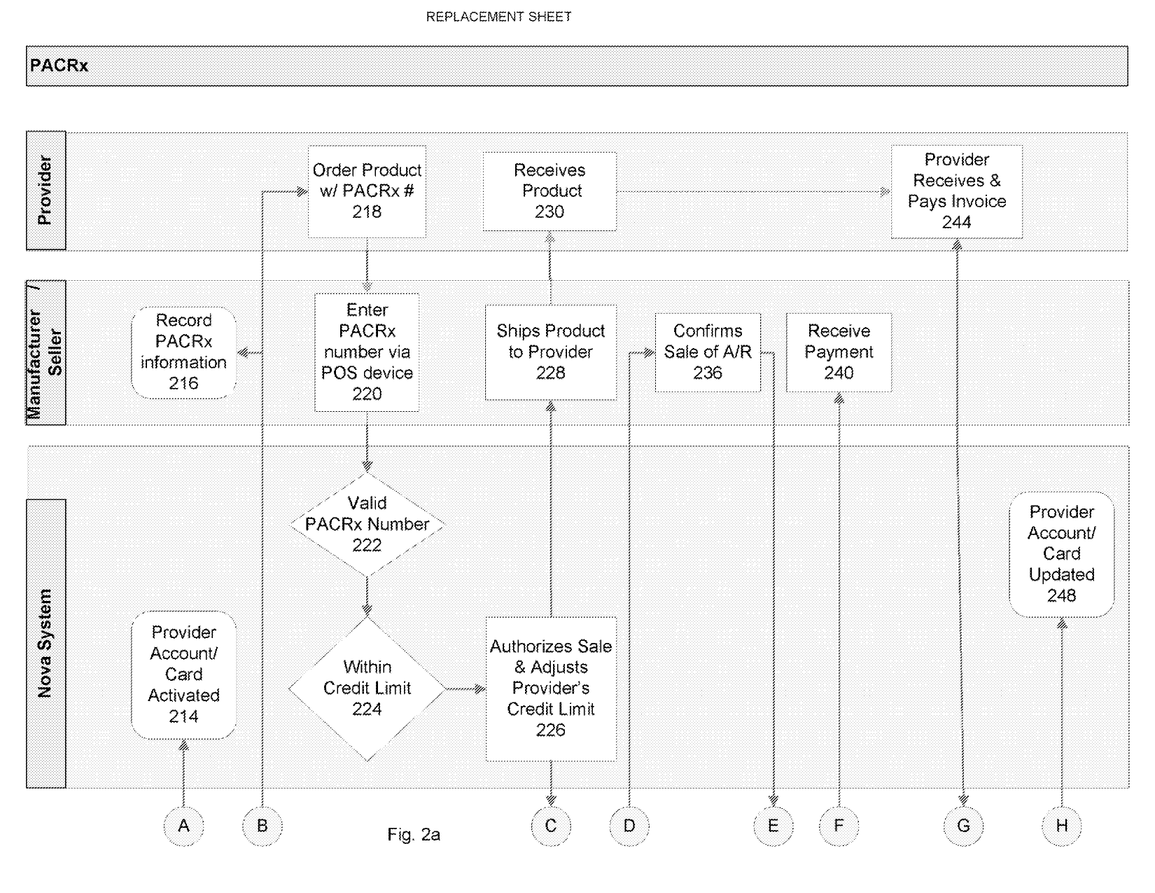

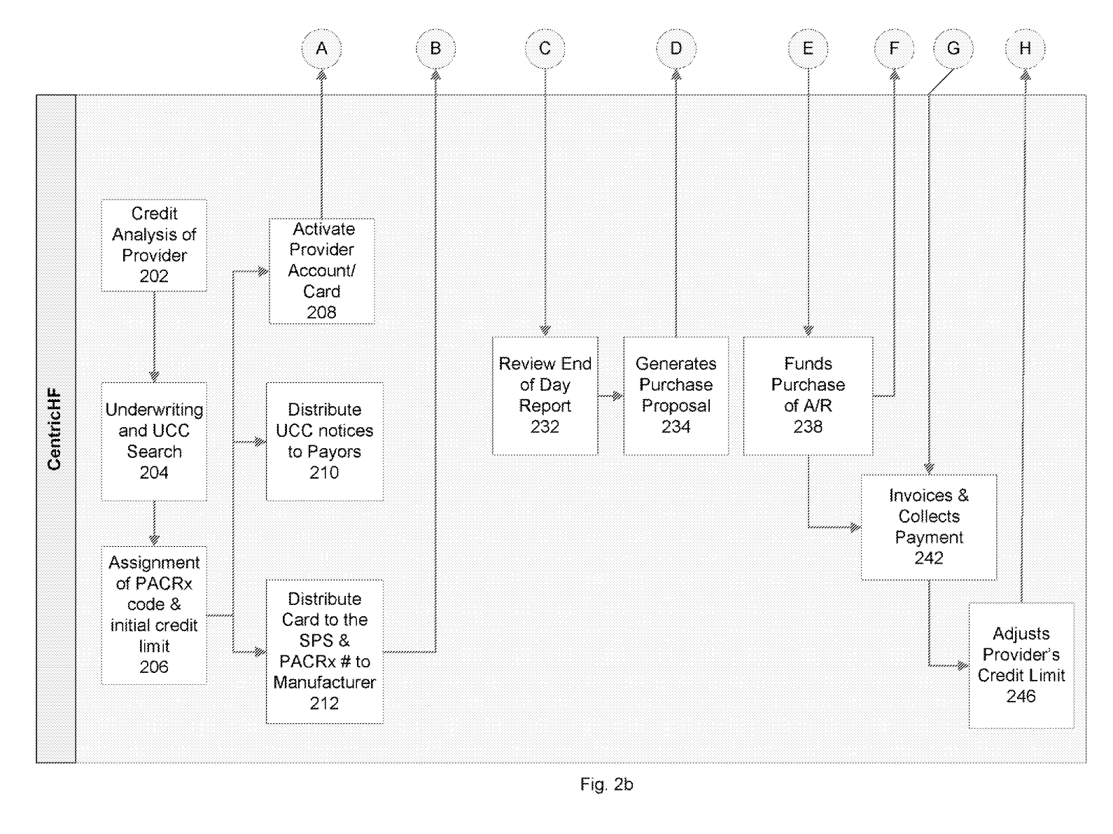

Then, Provider 106 becomes a part of Payment Facilitator 108's health care reimbursement system. Payment Facilitator 108 evaluates Provider 106 by performing certain credit analyses, as described in more detail below, on Provider 106 (step 202 of FIG. 2b). If accepted into The Payment Facilitator's program, Provider 106 is assigned a Customer Code and assigned a credit limit (step 206). The full customer code contains fields indicating that is participating in this program along with its credit limit and/or rating. The credit limit is determined, in part, by viewing average monthly claims history, Seller A/R data if available, and comparing those numbers to the credit score. Payment Facilitator 108 then activates the Provider's Account and PACRx card within the Nova System using either a Point of Sale (POS) terminal or a Nova portal (step 208), wherein the Nova portal may be an internet accessible web site enabling an electronic transaction, or alternatively may be implemented as an API to a dedicated payment system. Payment Facilitator 108 then distributes the card and account information to Provider 106 with a copy to Seller 112.

Payment Facilitator 108 then sends Provider 106's customer code and credit limit to Seller (step 212). Depending upon the Seller's systems and requirements, Payment Facilitator 108 and Seller 112 may share customer credit database information electronically (step 216). Then when Patient 102 seeks the medical services of Provider 106, most Americans rely on Insurance Company and/or Government 104 as a payor to help finance the costs of the services provided.

Payment Facilitator 108 gathers information about Provider 106 relating to the Provider's credit history and financial profile. Provider 106 is rated pursuant to a credit analysis involving traditional business credit analysis combined with a review of Payor Contracts, review of documentary compliance under Payor Contracts, and claims research regarding claims related to specific HCT's used by the Provider 106 (step 202). Payment Facilitator 108 also performs a UCC search to determine whether Provider's 106 A/R is pledged to or secured by a third party (step 204). From that information, Payment Facilitator 108 determines whether Provider 106 is eligible for the program and may establish a credit rating and credit limit electronically stored in Payment Facilitator 108's provider database and capable of submission and/or interface with the subject Seller's database through a web interface and/or electronic data interchange (EDI).

Once Provider 108 is accepted, Provider 108 is assigned a Customer Code and a credit limit is also set for Provider 108 (step 206). The full customer code contains fields indicating that the customer is participating in this program along with its credit limit and/or rating. The credit limit is determined, in part, by viewing average monthly claims history, Seller 112 A/R data if available, and comparing those numbers to the credit score. The Payment Facilitator 108 provides UCC notices to all Provider 106 payors in conformance with regulatory requirements (step 210). This information is used by Payment Facilitator 108 to rate each provider so that the character and quality of the transactions of each provider may be more accurately evaluated and used in reliable financial transactions.

In further embodiments of the present invention, step 206 may include performing a rating algorithm to develop a more sophisticated profile for Provider 106 so that calculations involving Provider 106 may be performed with a greater depth and breadth of information.

If Patient 102 requires a prescription, Provider 106 orders prescription from Seller 112 after Provider 106 has become enrolled as a customer. Provider 106 orders HCTs from Seller 112 using the PACRx card (step 218). Provider 106 submits the order in the same manner as previously utilized with the Seller (via the Web, electronically, telephonically, or otherwise). Seller 112 enters Provider's PACRx code into the POS device either by swiping the Provider's PACRx card or entering the information by hand (step 220). The POS device verifies Provider's PACRx Code is valid and then compares the order to the Provider's credit limit (steps 222, 224). If the PACRx Code and order amount are verified, the sale is approved and the POS debits Provider's PACRx account for the amount of the purchase (step 226). Seller 112 ships the product to Provider 106 (step 228) and prepares an invoice in normal course identifying Payment Facilitator 108 as the payee to Provider 116 with a copy sent to Payment Facilitator 108.

Once the HCT is delivered to the relevant shipping point per the applicable shipping terms (step 230), Seller 112 books the corresponding A/R as an asset. Seller 112 then sends to Payment Facilitator 108, through EDI, the End of Day report containing the A/R data, including the reference number, the invoice number, date, Provider name, PACRx Code, amount, date of delivery, and terms (step 232).

Payment Facilitator 108 confirms sale of A/R (step 236). Payment Facilitator 108 purchases and takes ownership of A/R from the Seller (step 238). Payment Facilitator 108 acquires the verified A/R either per transaction or in a daily or twice-daily batch. Payment Facilitator 108 pays the Manufacturer via ACH (Automated Clearing House) payment and takes immediate ownership of the Accounts Receivable (step 240). Payment Facilitator 108 collects from Provider 106 (steps 242, 244). Payment Facilitator 108 adjusts Provider's credit limit (step 246). Upon receiving payment from the Provider, Payment Facilitator 108 credits the Provider's PACRx account for the amount received through the secure web portal (step 248).

In a further embodiment of the invention, Patient 102 may have a co-payment obligation for therapeutics, so that both Patient 102 and Insurance Company 104 have a financial obligation to Provider 106 or Seller 112 for the delivery of an order of therapeutics. This co-payment obligation provides an additional account receivable that may be monetarized by Provider 106 and/or Seller 112.

When Payment Facilitator 108 receives payment from Provider 106 or from Patient 102 and/or Insurance Company/Government 104 pursuant to an assignment of such obligations, Payment Facilitator 108 adjusts Provider's credit limit and provides notice of such adjustment to Seller through an EDI process.

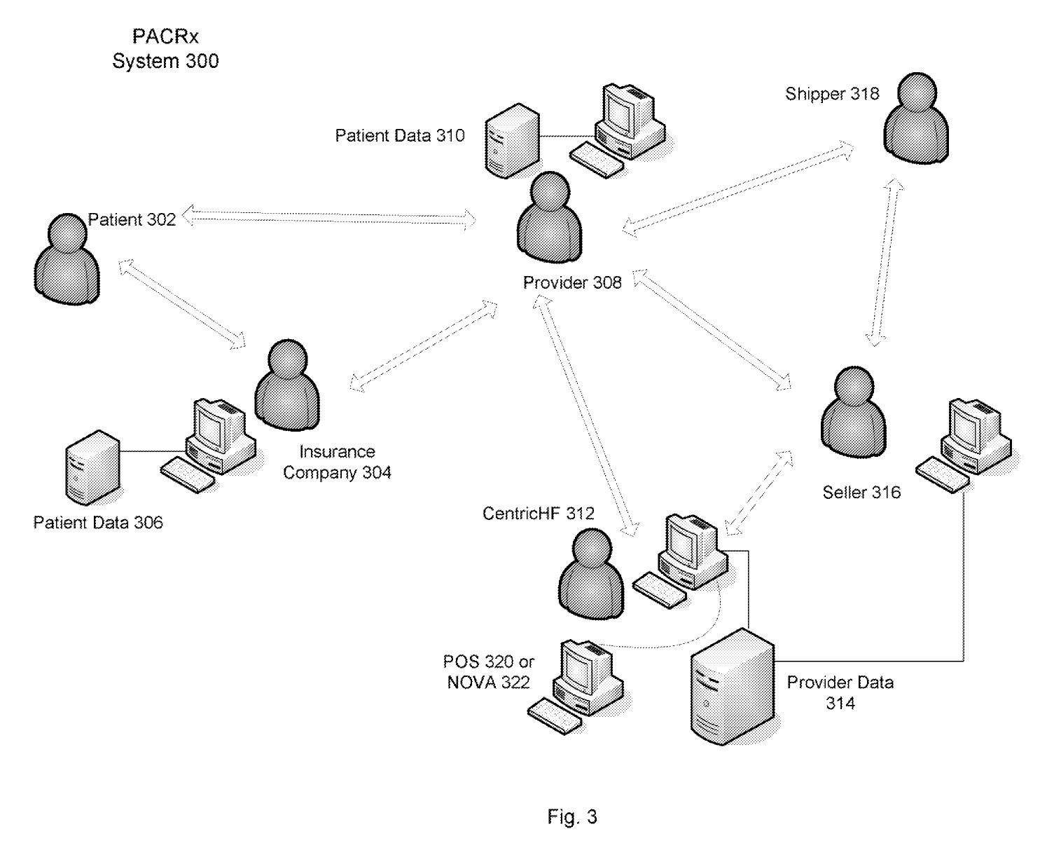

One implementation of the methods discussed above is depicted in computer and telecommunications system of FIG. 3. Seller 316 of high-cost therapeutics agrees to work within the program. Payment Facilitator 312 agrees to enter into such an agreement after evaluating the HCT involved, evaluating the system Seller 316 currently uses for invoicing and delivering the HCT, and obtaining Seller's agreement to provide to Payment Facilitator customer information after such customer's agree to participate in the Provider side of the program. Such information is stored electronically and Payment Facilitator 312 and the Seller 316 share customer credit information 314. A health care Provider wishing to join the program is evaluated via a credit analysis. Once Provider 308 is accepted, Provider 308 is assigned a Customer Code and credit limit which is stored in Provider database 314. Payment Facilitator 312 then activates the Provider's Account and card within the Nova System using either Point of Sale (POS) terminal 320 or Nova portal 322. Payment Facilitator 312 then distributes the PACRx card and account information to Provider 308.

If Patient 302 requires a prescription, Provider 308 orders the prescription from Seller 316 using the assigned Customer Code provided by Payment Facilitator 312 and stored in Provider database 314. Seller 316 verifies the Customer Code via Provider database 314. If the Customer Code is a valid code, Seller 316 verifies the Provider's credit limit database 314. If the order is within the customer's credit limits, then Seller 316 notifies Payment Facilitator 312 and Payment Facilitator 312 commits to acquiring A/R that falls within the commitment. Seller 316 then ships the drug to the Provider 308 via Shipper 318. Payment Facilitator 312 may verify the order directly with Provider 308.

Seller 316 then prepares an invoice for the order and Seller 316 classifies the invoice as an Account Receivable upon delivery of the drug to the shipping point or the destination. Seller 316 then submits to Payment Facilitator 312 through paper, facsimile, EDI, or web portal the Accounts Receivable data. Payment Facilitator 312 verifies the A/R data to the commitment data. Payment Facilitator 312 purchases the A/R by sending the reconciled A/R amount to Seller 316, less the applicable service fee, via electronic fund transfer (EFT) and Payment Facilitator 312 thereby acquires ownership and title of the A/R pursuant to provisions in the agreement. Payment Facilitator 312 later collects from Provider 308 and updates Provider data 314.

Patient 302 may have a co-payment obligation for therapeutics, so that both Patient 302 and Insurance Company 304 have a financial obligation to Provider 308 or Seller 318 for the delivery of an order of therapeutics.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A health care reimbursement method for a manufacturer of products providing an order to a health care provider, comprising the steps of:
a. obtaining ordering information from the manufacturer;
b. purchasing the order from the manufacturer;
c. shipping the order to the provider; and
d. collecting the order amount from the provider.

2. The method of claim 1, further comprising the steps of:
a. evaluating the provider; and
b. calculating the purchase amount to the manufacturer based on the evaluation of the provider.

3. The method of claim 1, further comprising the step of:
a. assigning a credit limit to the provider.

4. The method of claim 1, further comprising the steps of:
a. preparing an invoice by the manufacturer; and
b. notifying other parties of the details of invoice.

5. The method of claim 1, wherein details of the invoice are verified by the provider.

6. The method of claim 1, wherein shipping data is provided to other parties.

7. The method of claim 1, wherein said purchasing step includes obtaining ownership of an account receivable related to the order.

8. The method of claim 1, wherein said obtaining step includes obtaining an identification of a plurality of co-payment entities, and said purchasing step includes purchasing at least two accounts receivable from at least two of said plurality of co-payment entities.

9. The method of claim 1, further comprising the step of:
a. batching approved invoices.

10. A health care reimbursement method for a manufacturer of products providing an order to a health care provider, comprising the steps of:
a. obtaining rating information from the provider;
b. calculating a purchase price for an order based on the rating information and the order; and
c. purchasing the order from the manufacturer using the calculated purchase price.

11. The method of claim 8, further comprising the steps of:
a. shipping the order to the provider; and
b. collecting the order amount from the provider.

12. The method of claim 8, further comprising the step of:
a. assigning a credit limit to the provider.

13. The method of claim 8, further comprising the steps of:
a. preparing an invoice by the manufacturer; and
b. notifying other parties of the details of the invoice.

14. The method of claim 8, wherein details of the invoice are verified by the provider.

15. The method of claim 8, wherein the shipping data is provided to other parties.

16. The method of claim 8, further comprising the step of:
a. batching approved invoices.

17. A health care reimbursement method for a manufacturer of products providing an order to a health care provider, comprising the steps of:
a. obtaining profile information from the provider;
b. calculating a purchase price for an order based in part on the provider; and
c. purchasing the order from the manufacturer using the calculated purchase price.

18. The method of claim 15, further comprising the step of:
a. assigning a credit limit to the provider.

19. The method of claim 15, further comprising the steps of:
a. preparing an invoice by the manufacturer; and
b. notifying other parties of the details of invoice.

20. The method of claim 17, wherein details of the invoice are verified by the provider.

21. The method of claim 15, wherein shipping data is provided to other parties.

22. The method of claim 15, further comprising the step of:
a. batching approved invoices.
